(19) United States
(12) Patent Application Publication
(10) Pub. No.: US 2026/0179427 A1
(43) Pub. Date: Jun. 25, 2026

(54) LIGHTING ASSEMBLIES FOR ELECTRONIC GAMING MACHINES

(71) Applicant: Aristocrat Technologies, Inc., Las Vegas, NV (US)

(72) Inventors: Donald Rodd, Palm Beach Garden, FL (US); Timothy Barbour, Nolensville, TN (US)

(21) Appl. No.: 19/283,645

(22) Filed: Jul. 29, 2025

Related U.S. Application Data
(60) Provisional application No. 63/736,392, filed on Dec. 19, 2024.

(51) Int. Cl. G07F 9/02

(52) U.S. Cl. CPC G07F 9/0235

(57) ABSTRACT

Lighting assemblies are provided and may have a PCB having a PCB top side, a first plurality of LEDs on the PCB top side, a light blade having a light pipe portion, a lens portion, and an intermediate portion interposed between the light pipe portion and the lens portion; the intermediate portion is offset from the PCB top side, the light pipe portion is between the PCB top side and the intermediate portion, the lens portion extends away from the intermediate portion and has a distal end offset from the intermediate portion, the light pipe portion extends away from the intermediate portion in a second direction, has a front surface and a back surface having a reflective coating, opposite the front surface, and with an angled portion oriented at an acute angle to the second direction, and each LED is configured to emit light onto the front surface.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Electronic gaming machines are complex devices with display devices and are often housed within cabinets having various lights and lighting assemblies.

### SUMMARY

Details of one or more implementations of the subject matter described in this specification are set forth in the accompanying drawings and the description below. Other features, aspects, and advantages will become apparent from the description, the drawings, and the claims. The following, non-limiting implementations are considered part of the disclosure; other implementations will be evident from the entirety of this disclosure and the accompanying drawings as well.

In some embodiments, a lighting assembly is provided. The lighting assembly may include a printed circuit board (PCB) having a PCB top side and a PCB back side, a first plurality of light emitting diodes (LEDs) positioned on the PCB top side, and a first light blade having a monolithic body comprising a transparent material and having a light pipe portion, a lens portion, and an intermediate portion interposed between the light pipe portion and the lens portion. The intermediate portion may be offset from the PCB top side such that the light pipe portion is interposed between the PCB top side and the intermediate portion when viewed parallel to the PCB top side, the lens portion may extend away from the intermediate portion in a first direction, may have a proximal end at the intermediate portion, and a distal end offset from the intermediate portion, the light pipe portion may extend away from the intermediate portion in a second direction for a second length, may have a front surface, and may have a back surface opposite the front surface and with an angled portion, the angled portion may be oriented at an acute angle with respect to the second direction, the back surface may have a reflective coating, each LED may face the front surface of the light pipe portion, be offset from the front surface in a direction parallel to the PCB top side by a first offset distance, and be configured to emit light onto the front surface, and light emitted by each LED may be configured to pass through the front surface and a region of the light pipe portion, to hit the angled portion and thereby travel through the intermediate portion and the lens portion, and out the first light blade through the distal end.

In some embodiments, the front surface may have a covered portion with the reflective coating and a window portion without the reflective coating, the window portion and the angled portion may be opposite each other, and each LED may be configured to emit light onto the window portion of the front surface.

In some such embodiments, the window portion may be perpendicular to the PCB top side.

In some such embodiments, the window portion may have a transparency greater than 90% transparent.

In some embodiments, the light pipe portion may be in contact with the PCB top side.

In some embodiments, the first direction and the second direction may be parallel to each other.

In some embodiments, the second direction may be perpendicular to the PCB top side.

In some embodiments, the angle may range from 40 degrees to 50 degrees.

In some embodiments, the intermediate portion may have a top side and bottom side, the bottom side may face the PCB top side, and the bottom side may have the reflective coating.

In some embodiments, the intermediate portion may have a thickness, and the thickness and the second length may be configured to prevent a line of sight to the plurality of LEDs through the lens portion.

In some embodiments, the lens portion may have a tapered thickness along the first direction.

In some such embodiments, the lens portion may have a proximal region and a distal region, the proximal region may have the reflective coating, and the distal region may be larger than the proximal region and is without the reflective coating.

In some embodiments, the PCB and the first light blade may extend along a pathway for an assembly length, the LEDs may be offset from each other by a non-zero distance along the pathway, and the distal end of the lens portion may be offset from the intermediate portion by a variable offset distance along the pathway.

In some such embodiments, the variable offset distance may follow an oscillating curve with respect to the PCB top side.

In some embodiments, the PCB and the first light blade may extend along a pathway for an assembly length, the LEDs may be offset from each other by a non-zero distance along the pathway, and the pathway may be a curve.

In some embodiments, the distal end of the lens portion may be oriented at an obtuse angle with respect to the PCB top side.

In some embodiments, each LED may emit light in a cone pattern, and the LEDs may be offset from each other such that the cone pattern of each LED partially overlaps with the cone pattern of an immediately adjacent LED.

In some embodiments, the lighting assembly may further include a plurality of second LEDs positioned on the PCB top side, and a second light blade having a second monolithic body comprising a transparent material and having a second light pipe portion, a second lens portion, and a second intermediate portion interposed between the second light pipe portion and the second lens portion. The first light blade may be offset from the second light blade in the direction parallel to the PCB top side, the first plurality of LEDs may be offset from the second plurality of LEDs in the direction parallel to the PCB top side, the second intermediate portion may be offset from the PCB top side such that the second light pipe portion is interposed between the PCB top side and the second intermediate portion when viewed parallel to the PCB top side, the second lens portion may extend away from the second intermediate portion in the first direction, may have a second proximal end at the second intermediate portion, and a second distal end offset from the second intermediate portion, the second light pipe portion may extend away from the second intermediate portion in the second direction for the second length, may have a second front surface, and may have a second back surface opposite the second front surface and with a second angled portion, the second angled portion may be oriented at a second acute angle with respect to the second direction, the second back surface may have the reflective coating, each second LED may face the second front surface of the second light pipe portion, may be offset from the second front surface in the direction parallel to the PCB top side by the first offset distance, and may be configured to emit light onto the second front surface, and light emitted by each second LED may be configured to pass through the second front surface and a region of the second light pipe portion, to hit the second angled portion and thereby travel through the second intermediate portion and the second lens portion, and out the second light blade through the second distal end.

In some such embodiments, the PCB and the first light blade may extend along a pathway for an assembly length, the LEDs may be offset from each other by a non-zero distance along the pathway, the distal end of the lens portion may be offset from the intermediate portion by a variable offset distance along the pathway, the variable offset distance may follow an oscillating curve with respect to the PCB top surface, the second light blade may extend along the pathway for the assembly length, the second LEDs may be offset from each other by the non-zero distance along the pathway, the second distal end of the second lens portion may be offset from the intermediate portion by a second variable offset distance along the pathway, the second variable offset distance may follow a second oscillating curve with respect to the PCB top surface, and the oscillating curve may be out of phase with the second oscillating curve.

In some embodiments, an electronic gaming machine may be provided. The electronic gaming machine may include a cabinet defining an internal compartment, one or more display devices connected to the cabinet, and a lighting assembly positioned adjacent to an edge of the cabinet and having a printed circuit board (PCB) having a PCB top side and a PCB back side, a first plurality of light emitting diodes (LEDs) positioned on the PCB top side, a first light blade having a monolithic body comprising a transparent material and having a light pipe portion, a lens portion, and an intermediate portion interposed between the light pipe portion and the lens portion. The intermediate portion may be offset from the PCB top side such that the light pipe portion is interposed between the PCB top side and the intermediate portion when viewed parallel to the PCB top side, the lens portion may extend away from the intermediate portion in a first direction, have a proximal end at the intermediate portion, and a distal end offset from the intermediate portion, the light pipe portion may extend away from the intermediate portion in a second direction for a second length, may have a front surface, and may have a back surface opposite the front surface and with an angled portion, the angled portion may be oriented at an acute angle with respect to the second direction, the back surface may have a reflective coating, each LED may face the front surface of the light pipe portion, may be offset from the front surface in a direction parallel to the PCB top side by a first offset distance, and may be configured to emit light onto the front surface, light emitted by each LED may be configured to pass through the front surface and a region of the light pipe portion, to hit the angled portion and thereby travel through the intermediate portion and the lens portion, and the first light blade may extend away from the cabinet.

Additional aspects will be set forth in the detailed description which follows, and, in part, will be apparent from the disclosure, or may be learned by practice of the disclosed embodiments and/or the claimed subject matter.

The foregoing general description and the following detailed description are illustrative and explanatory and are intended to provide further explanation of the claimed subject matter.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an off-angle view of an electronic gaming machine, according to various implementations.

FIG. 5 depicts a magnified, detail view of a portion of the electronic gaming machine of FIG. 4.

FIG. 6 depicts an off-angle, magnified portion of the lighting assembly of FIG. 5.

FIG. 7 depicts another off-angle view of the lighting assembly of FIG. 6.

FIG. 8 depicts a cross-sectional side view of the lighting assembly of FIG. 7.

FIG. 9 depicts a cross-sectional view of a portion of FIG. 8.

FIG. 10 depicts a side view of another portion of the light assembly of FIG. 4.

FIG. 11 depicts a side view of another portion of the light assembly of FIG. 4.

FIG. 12 depicts the lighting assembly of FIG. 8 with a housing and a cover.

FIG. 13 depicts a cross-sectional view of another lighting assembly implementations.

FIG. 14 depicts another implementation of a lighting assembly.

FIG. 15 depicts another implementation of the lighting assembly of FIG. 14.

FIG. 16 depicts yet another implementation of the lighting assembly of FIG. 14.

FIG. 17 depicts the lighting assembly of FIG. 8 with another housing and cover.

FIG. 18 depicts a magnified, detail view of a portion of the electronic gaming machine of FIG. 4.

FIG. 19A depicts an off-angle view of an example end cap.

FIG. 19B depicts another off-angle view of the example end cap of FIG. 19A.

The Figures are provided for the purpose of providing examples and clarity regarding various aspects of this disclosure and are not intended to be limiting.

### DETAILED DESCRIPTION

The following discussion provides overall context for electronic gaming machines, some of which may include an enclosure such as those discussed later herein starting with FIG. 4.

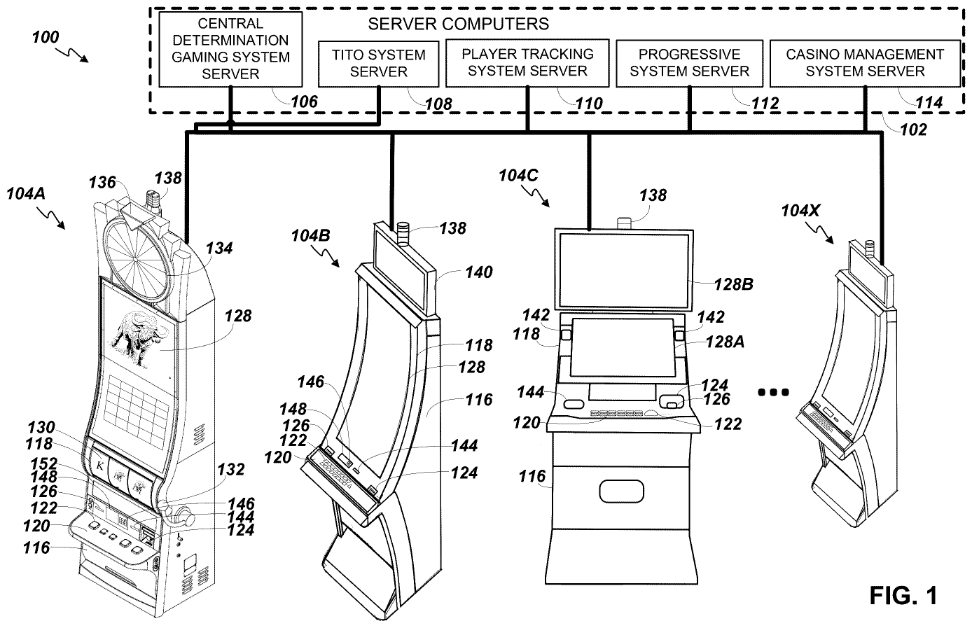

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

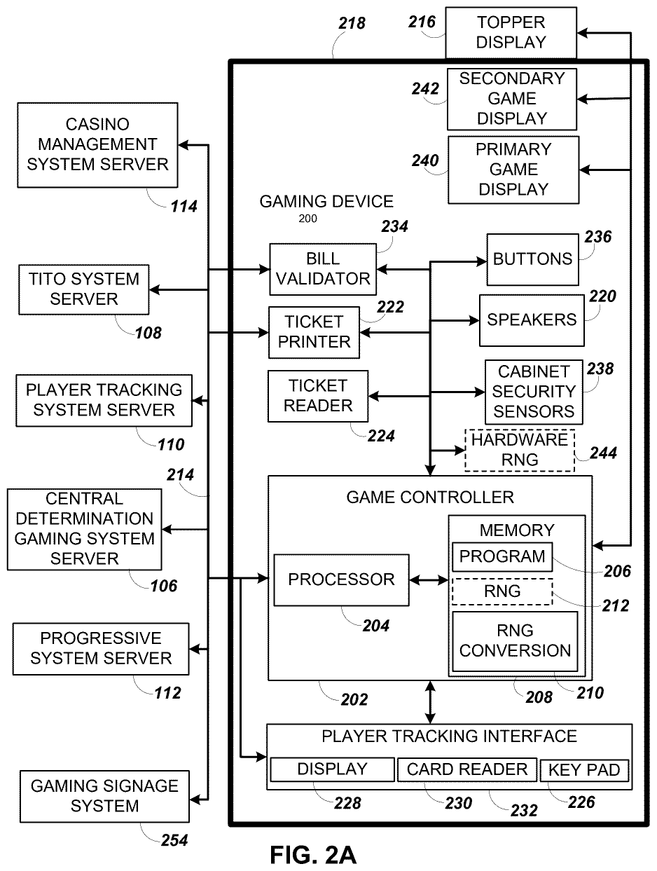

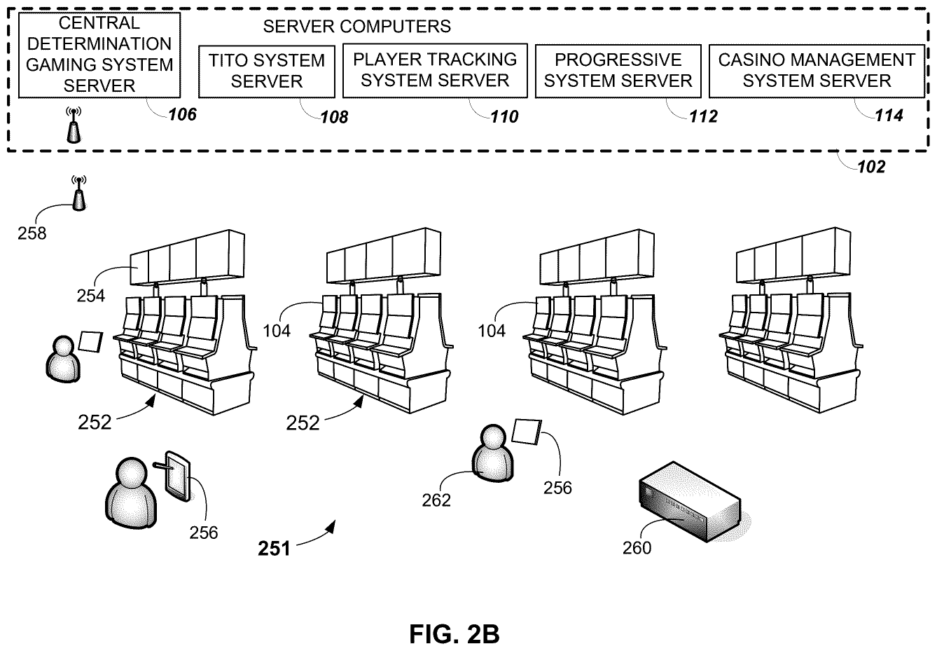

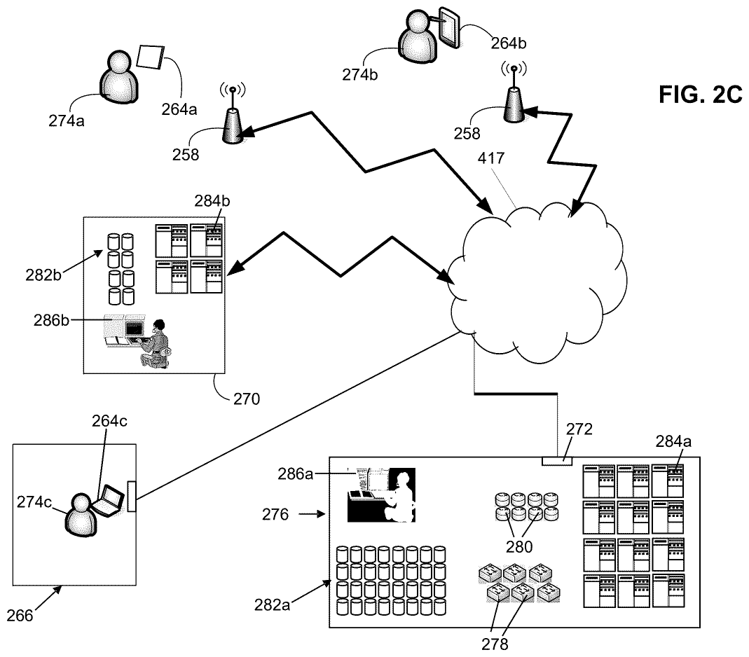

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

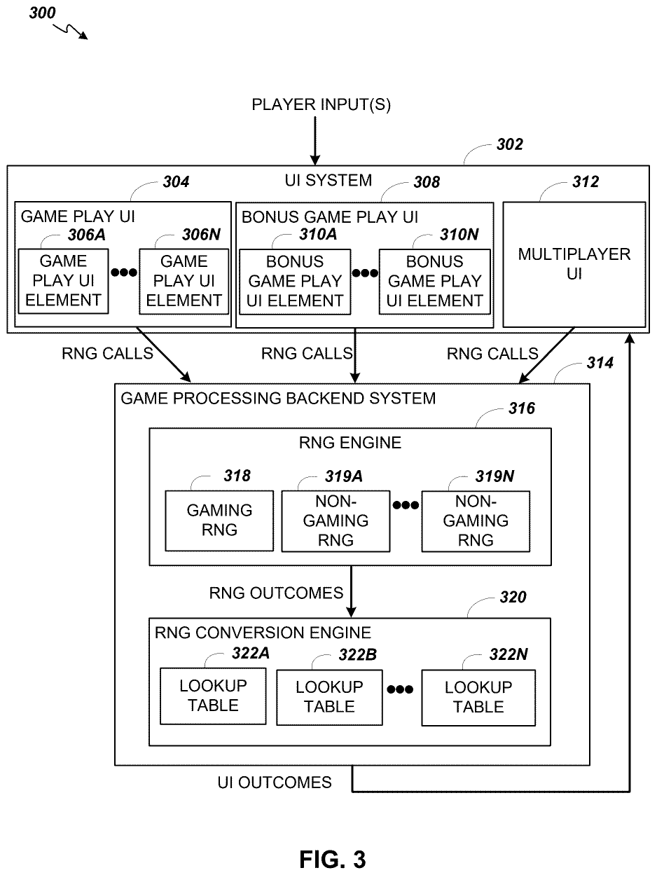

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Electronic gaming machines such as those discussed above may have various lights and lighting assemblies on the outside of their cabinets that serve numerous purposes. For example, the lights and lighting assemblies may attract potential users to use a particular electronic gaming machine (EGM) by illuminating in different manners, such as flashing or exhibiting sequences, and by providing an attractive appearance. In another example, the lights and lighting assemblies of EGMs may enhance a user's experience playing or interacting with an EGM. In some instances, the game play or other graphics may be synchronized or coordinated with the EGM's lights and lighting assemblies to provide additional visual stimuli beyond the display devices of the EGMs. However, many challenges exist in providing exterior EGM lights and lighting assemblies that are aesthetically pleasing. For instance, it is undesirable for users or other persons around the EGMs to have a direct line of sight to the light's emission source, the light emitting diode (LED). This can be challenging for lighting assemblies that are viewed at multiple angles by users and other persons moving around the EGM. Further, in some instances, when using multiple LEDs to illuminate a surface, it is undesirable to have uneven illumination of the surface, such as hot spots. It is also undesirable for lights in one lighting assembly to bleed into an adjacent lighting assembly.

Provided herein are new and novel lighting assemblies that provide numerous advantages. The lighting assemblies described herein prevent a line of sight to the lights, such as the LEDs, from multiple angles, prevent hot spots from being visible, and prevent light bleeding into adjacent lighting assemblies. These new lighting assemblies may also be used in various implementations, such as on EGMs. Although the lighting assemblies are described in the context of EGMs, these lighting assemblies are applicable to other contexts, such as vending machines and signs.

In some implementations, the lighting assemblies have a printed circuit board (PCB) with a plurality of LEDs positioned on a top side of the PCB. Positioned adjacent to and above the PCB is a light blade made of a transparent, or semitransparent, material that has a light pipe portion, a lens portion, and an intermediate portion interposed between the light pipe portion and the lens portion. The light pipe portion and the lens portion extend from different sides of the intermediate portion and in different directions. The light pipe portion extends towards the PCB top side and is adjacent to the LEDs. The LEDs are configured to emit light at the light pipe portion in a first direction, which may be parallel to the PCB top side. The light pipe portion is configured to receive the emitted light and direct the light in a different, second direction, which may be perpendicular to the first direction. To redirect the emitted light, the light pipe portion has a back surface with an angled portion and a reflective coating. In some instances, this angled portion may be oriented at an angle from about 40 degrees to about 50 degrees, including 45 degrees, with respect to the PCB top side or the first direction. The light pipe portion and a bottom surface of the intermediate portion may have a reflective coating thereon that is configured to retain the light within the light pipe portion and the intermediate portion, and to cause the light received by the light pipe portion to scatter, reflect, refract, and become diffused within the light pipe portion and intermediate portion. To receive the light from the LEDs, the light pipe portion may also have a window portion that is without any reflective coating and that has transparency greater than 90% transparent.

The light in the light pipe portion is configured to be redirected upwards towards the intermediate portion and the lens portion, and to exit the light blade through a distal end of the lens portion. In some instances, little to no light is visible in the sides of the lens portion. In some implementations, the lens portion has a tapered thickness that decreases as the distance from the intermediate portion increases. A region of the lens portion may have the reflective coating which is also configured contain within a section of the lens portion and also direct the light upwards and out the distal end of the lens portion.

FIG. 4 depicts an off-angle view of an electronic gaming machine, according to various implementations. The EGM 404 has a main cabinet 416 having a display device, such as a main display 428 configured to display various content, and a secondary display 428B above the main display 428. As can be seen, the main cabinet 416 has a front edge 421 that has curves, including with both a convex curve portion 421A and a concave curve portion 421B. Also visible in FIG. 4 is a lighting assembly 423 encompassed by the dashed shape that has two lenses with edges following oscillating wave patterns that are out of phase from each other.

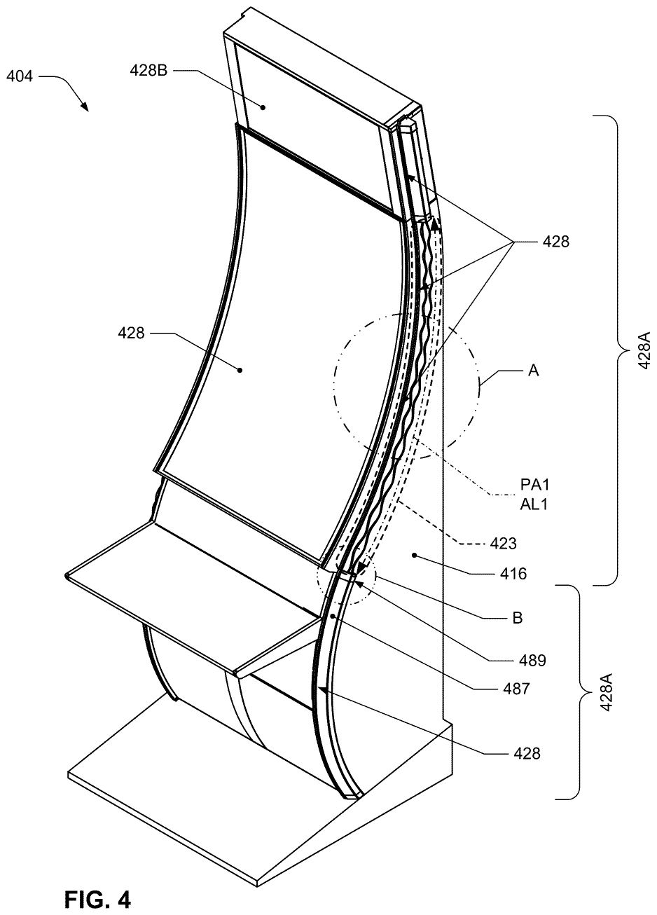

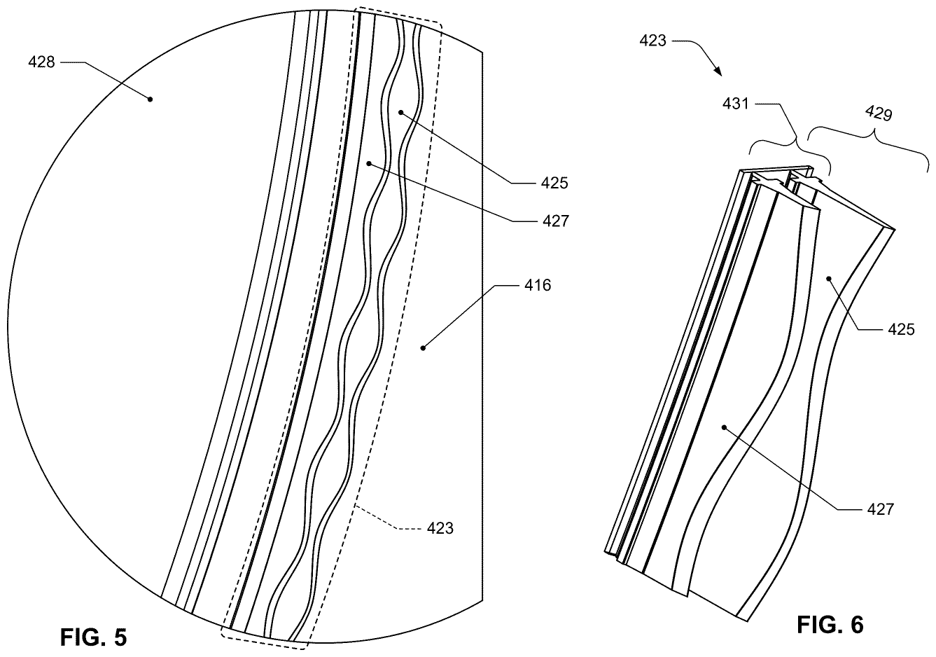

FIG. 5 depicts a magnified, detail view of a portion of the electronic gaming machine of FIG. 4, as identified by detail A in FIG. 4. A portion of the main display 428, the main cabinet 416, and the lighting assembly 423 are shown and identified. As discussed in more detail below, the lighting assembly 423 has a first light blade having a lens portion 425 and a second light blade having a second lens portion 427 and these lens portions have distal ends at variable heights that follow out of phase oscillating wave patterns. FIG. 6 depicts an off-angle, magnified portion of the lighting assembly of FIG. 5. Here, the first light blade 429 is identified and it has multiple portions, described in more detail below, including the lens portion 425. The second light blade 431 is also identified and it has multiple portions, including the second lens portion 427.

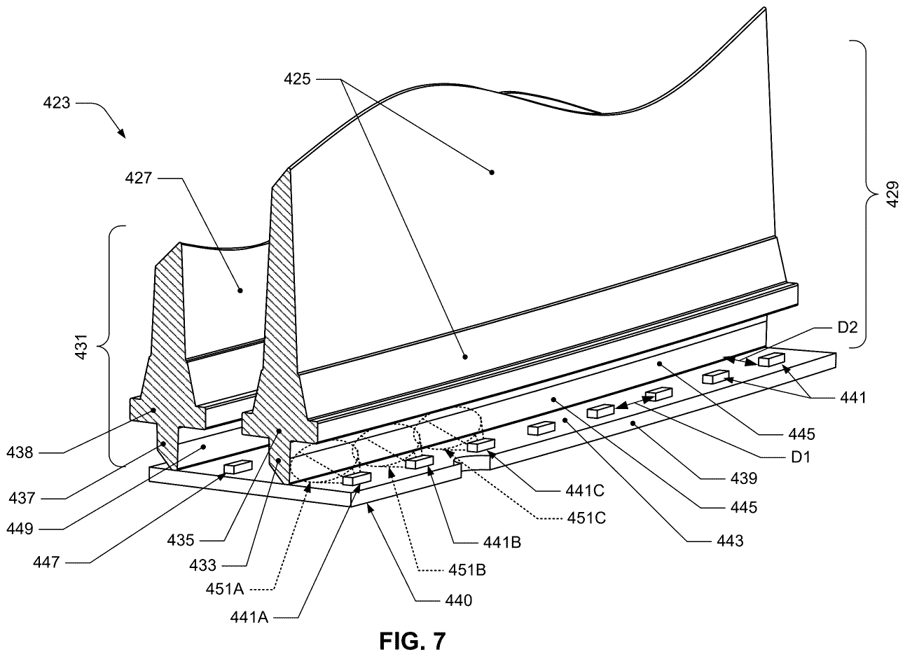

FIG. 7 depicts another off-angle view of the lighting assembly of FIG. 6. As mentioned above, each light blade has a light pipe portion, an intermediate portion, and a lens portion. The light blades are comprised of a transparent material, such as a polymer or glass. In some instances, the transparent material may have a transparency that is greater than 90% transparent, 95% transparent, or 99% transparent. The light from the LEDs is emitted into the light pipe portion and redirected within the transparent material of each light blade to reach the distal end of lens and exit the light blades from the distal end. The light blades have various features and surfaces, including one or more angle surfaces and a reflective coating, configured to contain and redirect this emitted light.

In FIG. 7, the first light blade 429 has the lens portion 425, the light pipe portion 433, and the intermediate portion 435 interposed between the lens portion 425 and the light pipe portion 433. Similarly, the second light blade 431 has the second lens portion 427, a second light pipe portion 437, and a second intermediate portion 438 interposed between the second lens portion 427 and the second light pipe portion 437. In some implementations, like illustrated in FIG. 7, each light blade may be a contiguous, monolithic body that is made of the transparent material, and not made of separable parts. The overall body of each light blade has the lens portion 425, the light pipe portion 433, and the intermediate portion 435.

The lighting assembly 423 also has a printed circuit board (PCB) 439 with a first plurality of LEDs 441 positioned on a PCB top side 443 of the PCB 439, which are represented as rectangular boxes and three of which are identified. The PCB 439 also has a PCB bottom side 440 opposite the PCB top side 443. The LEDs 441 are configured to emit light onto the light pipe portion 433 of the first light blade 429. In some instances, the light pipe portion 433 has a front surface 445 that faces the LEDs 441. The front surface 445 may have a window portion configured to receive the light emitted by the LEDs 441 and allow that emitted light to pass through the light pipe portion 433. This emitted light travels through the light pipe portion 433 and hits a back surface of the light pipe portion 433 which has an angled surface, discussed below, which causes the light to change directions and travel upwards towards the lens portion 425.

The PCB 439 also has a second plurality of LEDs 447 positioned on the PCB top side 443, one of which is visible and identified. Similar to the first plurality of LEDs 441, these LEDs 447 are configured to emit light onto the second light pipe portion 437 of the second light blade 431. The second light pipe portion 437 may also have a second front surface 449 that faces the LEDs 444 and has a second window portion configured to receive the light emitted by the LEDs 447. The emitted light passes through the second light pipe portion 437 to a second back surface of the second light pipe portion 437 which has a second angled surface which causes the light to change directions and travel upwards towards the second lens portion 427.

In some implementations, each LED is configured to emit light in a cone pattern, as illustrated with LEDs 441A, 441B, and 441C. To provide uniform lighting without hot or cold spots, the LEDs are positioned away from each other on the PCB top side such that their cone patterns partially overlap with the immediately adjacent LEDs. If the LEDs are positioned too far apart, then the resulting light emitted by the LEDs may appear as having hot or cold spots, or uneven. If the LEDs are positioned too close together, the lighting may again look uneven and may increase costs and complexity, all of which are unwanted. Similarly, the LEDs are offset away from the light pipe portion so that the light emitted by each one can enter the light pipe portion 433 in a desirable diffuse manner. As also seen in FIG. 7, the LEDs 441 are offset from each other by a non-zero distance D1, and offset from the light pipe portion by a second non-zero distance D2, which causes the cone patterns 451A, 451B, 451C of LEDs 441A, 441B, and 441C, respectively, to expand and partially overlap with each other. For example, the light cone pattern 451B emitted by LED 441B partially overlaps with the LEDs immediately adjacent to each side of the LED 441B, which are LEDs 441A and 441C. This illustrative overlap provided between the light emitted of immediately adjacent LEDs prevents visual hot spots from forming.

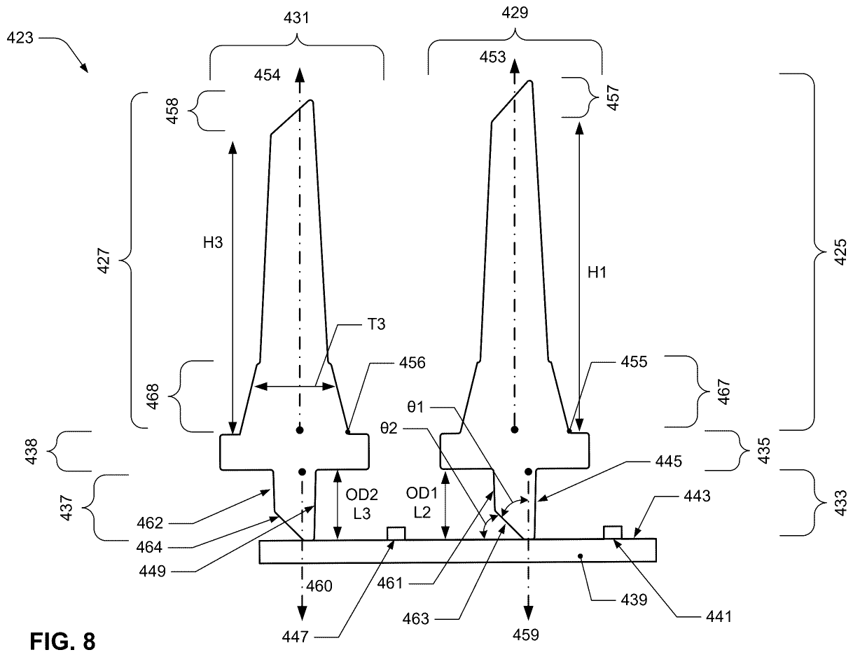

Additional or alternative features of the lighting assemblies are further discussed in FIG. 8 which depicts a cross-sectional side view of lighting assembly of FIG. 7. This FIG. 8 is viewed at an angle parallel to the PCB top side 443 and for clarity, no cross-hatching is shown. The first light blade 429 will be discussed first. The lens portion 425, the light pipe portion 433, and the intermediate portion 435 are identified, along with the PCB top side 443 and one LED 441 of the first plurality of LEDs. The intermediate portion 435 is offset from the PCB top side 443 by an offset distance OD1 such that the light pipe portion 433 is interposed between the PCB top side 443 and the intermediate portion 435. The lens portion 425 extends away from the intermediate portion 435 in a first direction 453 which may, in some instances, be perpendicular to the PCB top side 443. The lens portion 425 also may be considered to extend away from the PCB top side 443. The lens portion 425 has a proximal end 455 at the intermediate portion 435 and a distal end 457 offset from the intermediate portion by a first height H1. As provided herein, this first height H1 may be a variable height along a pathway of the first light blade 429.

The light pipe portion 433 also extends away from the intermediate portion 435, but from a different side and different direction than the lens portion 425. Here, the light pipe portion 433 extends away from the intermediate portion 435 in a second direction 459 for a second length L2 that may be the same distance as the first offset distance OD1. The second direction may, in some instances, be parallel to the first direction 453 and/or perpendicular to the PCB top side 443. The light pipe portion 433 also extends between the intermediate portion 435 and the PCB top side 443. In some instances, the light pipe portion 433 may be in contact with the PCB top side 443, as illustrated. This may advantageously retain the light emitted from the first plurality of LEDs 441 and prevent their emitted light from bleeding or leaking over to the second light blade 431.

As provided above, the first light blade is configured to contain and redirect the light emitted by the LEDs. For example, the light pipe portion 433 has the front surface 445 that faces the LEDs, such as LED 441, and has a back surface 461 opposite the front surface 445 and with an angled portion 463. In some implementations, the angled portion 463 may be oriented with respect to the second direction 459 at a first angle θ1. The first angle θ1 may range from about 30 degrees to about 60 degrees, and may be about 45 degrees, for example. In some instances, the angled portion 463 may be measured with respect to the PCB top side 443 at a second angle θ2. The second angle θ2 may range from about 30 degrees to about 60 degrees and may be about 45 degrees, for example. The back surface 461, including the angled portion 463, may have the reflective coating applied thereon which is configured to cause the angled portion 463 to reflect the light emitted by the LED 441 and redirect the light to one or more different directions through and within the first light blade 429.

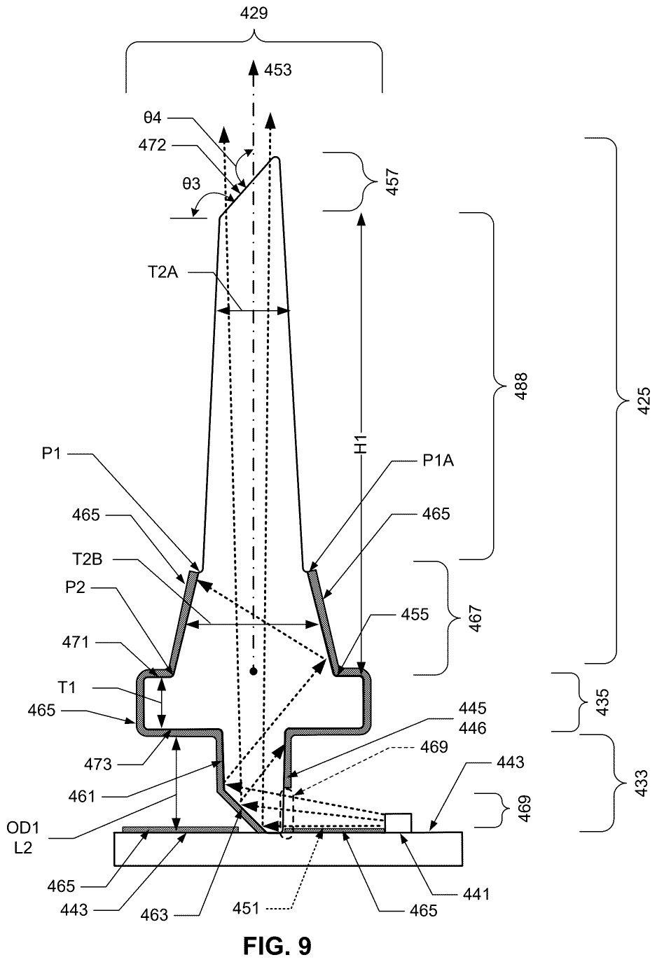

Other aspects of the first light blade may have the reflective coating thereon to cause the aspects of the first light blade to contain the light within it and cause the light to exit the first light blade through distal end 457 of the lens portion 425. FIG. 9 depicts a cross-sectional view of a portion of FIG. 8. Here, the first light blade 429, one LED 441, and a portion of the PCB top side 443 are shown. For clarity, the second light blade is not shown, and some labels have been removed. A reflective coating 465 is illustrated as a shaded shape and as can be seen, the reflective coating 465 is positioned on the back surface 461 including the angled portion 463. In some implementations, like in FIG. 9, the reflective coating 465 is also positioned on surfaces of the intermediate portion 435, a portion of the front surface 445, and a proximal portion 467 of the lens portion 425. For example, the intermediate portion 435 has a top side 471 that faces away from the PCB top side 443 and a bottom side 473 that faces the PCB top side 443. As shown, the reflective coating 465 is positioned on both the top side 471 and bottom side 473. For the lens portion 425, it has the proximal portion 467 with the reflective coating positioned thereon, and a distal region 488 without the reflective coating. In some instances, the distal region 488 may be larger than the proximal portion 467. The reflective coating 465 may also be positioned on the PCB top side 443, as illustrated, which may advantageously redirect light into the light pipe portion 433. This may include in between the LEDs and light pipe portion 433. In some implementations, the reflective coating 465 has a reflective color, such as silver or white, and it may be a tape or a paint applied to the first light blade 429.

As illustrated here, in some implementations the front surface 445 is partially covered by the reflective coating 465. For instance, the front surface 445 has a covered portion 446 with the reflective coating 465 thereon and has a window portion 469 without any reflective coating and that allows light from the LED 441 to enter the light pipe portion 433. This window portion 469 is highlighted with a dashed rectangle. In some instances, the window portion 469 may have a transparency greater than 80% transparent, 90% transparent, 95% transparent, or 99% transparent. The window portion 469 may be oriented perpendicular to the PCB top side 443, perpendicular to the LEDs 441, or both as illustrated here.

Light 451 emitted by the LED 441 is illustrated shining through the front surface 445 of the light pipe portion 433, including through the window portion 469. The emitted light travels through the light pipe portion 433 and to the angled portion 463. Once the light 451 hits or strikes the angled portion 463, the light 451 reflects off the reflective coating 465 and is redirected to one or more different directions within the first light blade 429. The light 451 is configured to be contained within the light pipe portion 433, the intermediate portion 435, and the proximate portion 467 by the reflective coating 465. In some instances, like illustrated in FIGS. 7 and 9, the LEDs 441 are side firing, or side emitting. These LEDs 441 may be considered to emit their light in a cone or pattern in a direction parallel to the PCB top side 443, or in a direction that has a directional component parallel to the PCB top side 443. In some implementations, these LEDs 441 are positioned and oriented to face the front surface 445. The direction that the LEDs 441 emit their light may be perpendicular to the window portion 469 of the light pipe portion 433, in some instances.

In some implementations, the lens portion 425 may have various features configured to assist with containing and redirecting the light within the first light blade 429. This configuration may include the proximal portion 467 having the reflective coating 465 positioned thereon. This configuration may also include the lens portion 425 having a tapered thickness T2 that varies over its height H1. This tapering may decrease as the distance from the intermediate portion 435 increases. The lens portion 425 may have the largest thickness at the proximal end 455 and the smallest thickness at the distal end 457. For instance, the thickness T2A is smaller than the thickness T2B which is closer to the proximal end 455 than thickness T2A. This configuration may focus the light within the intermediate portion 435 and the proximal portion 467 and cause the light to be emitted towards the distal end 457 and not to be emitted out the sides of the lens, such as the distal region 488. In some implementations, the distal end 457 may have an end surface 472 that is oriented at a non-parallel angle with respect to the PCB top side 443. For example, the end surface 472 may be oriented at an obtuse angle θ3, such as 135 degrees, from a plane parallel to the PCB top side. The end surface 472 may also be oriented with respect to the first direction 453 at an obtuse angle θ4.

The lighting assembly is advantageously configured to prevent a line of sight to the LEDs. This configuration may include the intermediate portion 435 having a thickness T1 and the second length L2 that are long enough to prevent a line of sight to the LED 441 through the lens portion 425 or the intermediate portion 435. For example, in FIG. 9, from points P1 or P2, there is no direct line of sight to the LED 441. There is also no line of sight to the LED through the lens portion 425 from any angle between points P1 or P1A. The reflective coating 465 may also prevent a direct line of sight to the LED 441, and even without the reflective coating 465 on the proximal portion 467, there is still no direct line of sight to the LED 441.

In some implementations, the lighting assembly 423 may have features configured to diffuse the light emitted by the LEDs. For example, one or more surfaces of the first light blade 429 may have texturing configured to cause the light to scatter, reflect, and/or refract and thereby become diffuse. In some instances, this texturing may be provided by sand-blasting or otherwise roughening the one or more surfaces. Such texturing may be applied or provided before the reflective coating 465 is positioned thereon. For example, the texturing, sometimes called “frosting”, of the one or more surfaces of the light blades may undergo a surface treatment to cause this texturing, such as a laser etch, a chemical etch, or the sand-blasting. In some instances, the light blades are formed with a mold and the mold may have texturing features inside which in turn create the negative, or converse, of this texturing on the light blade. In some implementations, the reflective coating itself may have texturing or light scattering properties that are also configured to cause the light to scatter, reflect, and/or refract and thereby become diffuse. The one or more surfaces having these features may be the covered portion 446 of the front surface 445, the back surface 461, the top side 471 and the bottom side 473 of the intermediate portion 435, the proximal portion 467 of the lens portion 425, or a combination thereof. Diffusing the light emitted by the LEDs may assist with causing the light to emit from the distal end 457 and not from other areas of the lens portion 425.

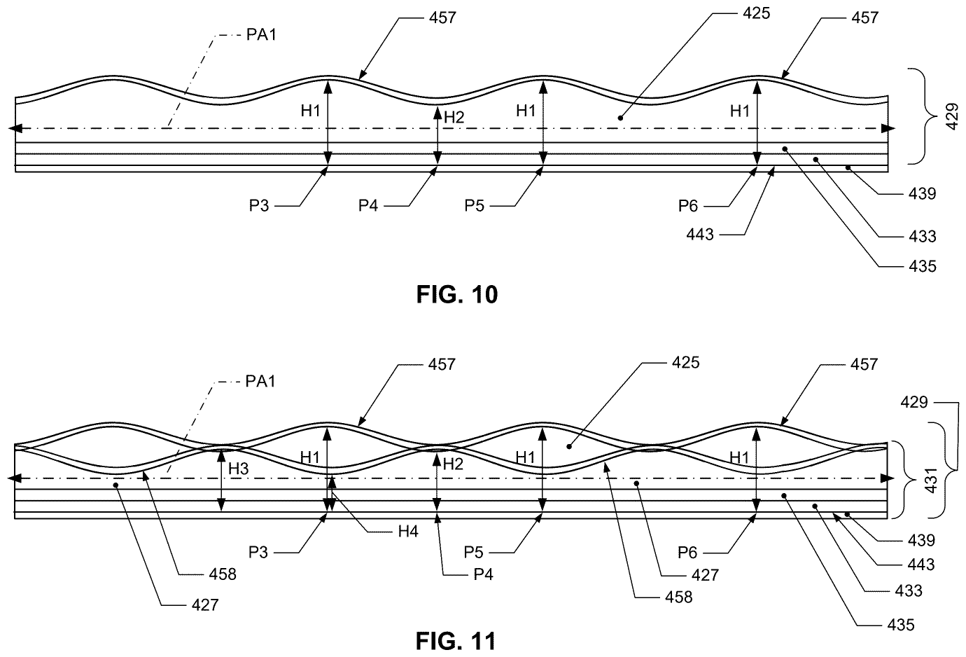

As provided above, the lens portions may have a variable height that repeats in an oscillating curve along the length of the first light blade. FIG. 10 depicts a side view of another portion of the light assembly of FIG. 4. The PCB 439 and first light blade 429 having the light pipe portion 433, intermediate portion 435, and lens portion 425 are shown. The PCB 439 and first light blade 429 extend along, or follow, a pathway PA1 for an assembly length. In this Figure, the pathway appears linear and in some instances, the pathway PA1 may be curved, as illustrated in FIG. 4, for example. In FIG. 4, the pathway PA1 along the assembly length AL1 is curved, such as an arc. Referring back to FIG. 10, the distal end 457 of the lens portion 425 has a variable height along the pathway PA1 that repeats in a periodic manner. In some instances, the variable height may be an oscillating curve with respect to the PCB top side 443 that repeats. This oscillation may be considered a sinusoidal curve. For example, between points P3 and P5 the lens portion 425 height varies in a curved manner. The lens portion 425 has a height H1 at point P3, a minimum height H2 and at point P4, and the same height H1 at point P5. From point P5 to point P6, the lens height repeats the same height variability as between points P3 and P5. This variable height pattern also repeats along the pathway PA1 for the assembly length AL1.

Some features of the second light blade will now be discussed. Referring back to FIG. 8, the second light blade 431 may have the same or similar features and configurations as the first light blade 429. For instance, the second light blade 431 may have the same configurations as the first light blade 429 described herein and shown in FIGS. 8 and 9, except that the height of the second lens portion 427 is different than the lens portion 425, such as shorter. For instance, the second light blade 431 has the second light pipe portion 437 and the second intermediate portion 438 interposed between the second lens portion 427 and the second light pipe portion 437. The second lens portion 427 extends away from the intermediate portion along a third direction 454 for a third height H3 that may be less than the first height H1 of the lens portion 425. The third direction 454 may be parallel to the first direction 453 and may be perpendicular to the PCB top side 443. The second lens portion 427 may also be configured similarly to the lens portion 425, such as having a second distal end 458, the proximal end 456, a second proximal portion 468 adjacent to the second intermediate portion 438, and a tapered thickness T3 that decreases as the distance from the second intermediate portion 438 increases.

The second light pipe portion 437 may be configured the same as the light pipe portion 433. For example, it may extend in a fourth direction 460 for a third length L3 that may be the same as the second length L2. The second intermediate portion 438 may also be offset from the PCB top side 443 by a second offset distance OD2 that may, in some instances, be the same as the first offset distance OD1. The second light pipe portion 437 may also have the second front surface 449 and a second back surface 462 opposite the second front surface 449 and that has a second angled portion 464. The second angled portion 464 may be angled with respect to the PCB top side 443 at an acute angle, like angle θ2, or angled with respect to the fourth direction 460 at another acute angle, like angle θ1. These angles may be the same as above, such as between 40 degrees and 50 degrees, including about 45 degrees.

The LEDs of the second plurality of LEDs, such as LED 447, are also configured to emit light onto the second front surface 449 as described for the first plurality of LEDs 441. This includes their overlapping light cone patterns as well as their emission of light onto a window portion of the second front surface 449. The second light blade 431 may also have a reflective coating positioned on various surfaces like the first light blade 429. This may include the reflective coating on the second back surface 462, a portion of the second front surface 449, a top side and bottom side of the second intermediate portion 438, and on the second proximal portion 468. The reflective coating is not illustrated in FIG. 8 for clarity, but it may be in the same positions as illustrated in FIG. 9 with respect to the first light blade 429.

In some implementations, the second light blade 431 may also have a variable height with respect to the second intermediate portion 438 or the PCB top side 443. When positioned with respect to the PCB and the first light blade 429, the second distal end 458 of the second lens portion 427 may also be an oscillating curve, and it may be out of phase with the oscillating curve of the first light blade. By being out of phase, the maximum height of the first lens portion may occur at the minimum height of the second lens portion, and the maximum height of the second lens portion may occur at the minimum height of the first lens portion. FIG. 11 depicts a side view of another portion of the light assembly of FIG. 4. Here in FIG. 11, both the first and second light blades 429 and 431 are illustrated. The first light blade 429 has the lens portion 425 with the distal end 457 and the second light blade 431 has the second lens portion 427 with a second distal end 458. As can be seen, the distal ends 457 and 458 of the first and second light blades 429 and 431 have variable heights that repeat in oscillating curves along their lengths.

For example, like in FIG. 10, in FIG. 11 the PCB 439, first light blade 429, and second light blade 431 extend along, or follow, the pathway PA1 for the assembly length and the pathway appears linear. The distal end 457 of the lens portion 425 has the variable height along the pathway PA1 that repeats in a periodic manner, and the second distal end 458 of the second lens portion 427 also has a variable height along the pathway PA1 that repeats in a periodic manner. In some instances, these variable heights may be oscillating curves with respect to the PCB top side 443 that repeat. These oscillations may each be considered a sinusoidal curve and the oscillating curves of the first light blade 429 may be out of phase with the second light blade 431. For example, between points P3 and P5 the lens portion 425 height and the second lens portion 427 height vary in curved manners. The lens portion 425 has the height H1 at point P3, the minimum height H2 and point P4, and the same height H1 at point P5. In contrast, at point P3, the second lens portion has height H4 which may be its lowest height, at point P4 it may have the same height H2 as the lens portion 425 which may be its highest height, and at P5 it again has the height H4. From point P5 to point P6, the lens portion 425 height and the second lens portion 427 height repeat the same height variability as between points P3 and P5.

The lighting assembly may also have a housing around various aspects of the assembly. For example, the lighting assembly may have a transparent cover extending over the first and second lens portions to prevent dust, smoke, and other contaminants from contacting the lens portions, the PCB, and the LEDs, as well as protecting the lighting assembly from damage or contact by objects or people. The lighting assembly may also have a housing around the proximal portions of the lens portions to further protect the PCB and prevent visibility to the LEDs on the PCB.

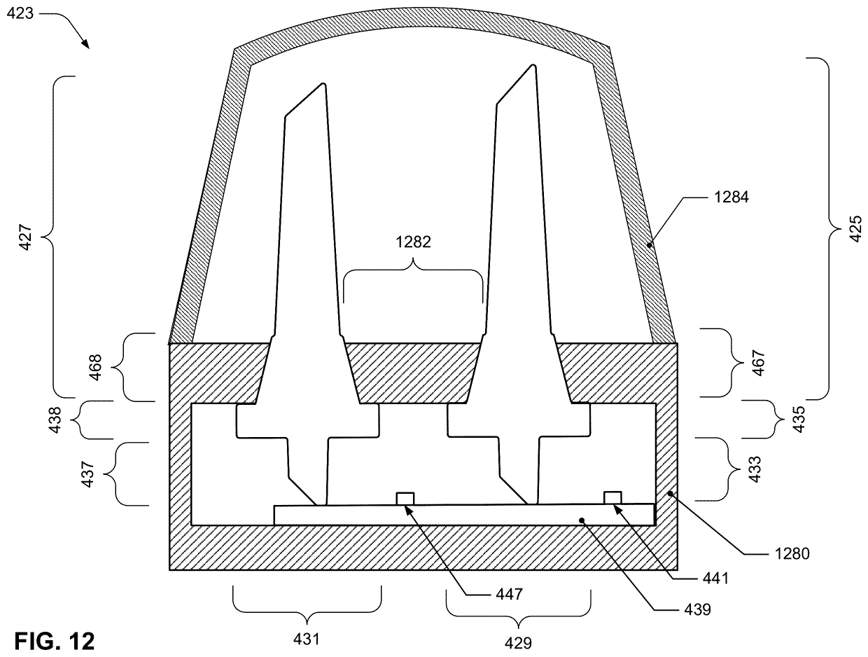

FIG. 12 depicts the lighting assembly of FIG. 8 with a housing and a cover. The lighting assembly 423 has the same first and second light blades 429 and 431 described above and shown in FIGS. 7 to 11. For brevity, the features of first and second light blades 429 and 431 are not repeated here. The lighting assembly 423 has a housing 1280 that is positioned around the PCB 439, the first and second pluralities of LEDs 441 and 447, the intermediate portion 435, the light pipe portion 433, the second intermediate portion 438, and the second light pipe portion 437. The housing 1280 also extends around some or all of the proximal portion 467 of the lens portion 425 and the second proximal portion 468 of the second lens portion 427. This may include the housing 1280 extending in a region 1282 between the first light blade 429 and the second light blade 429. This housing 1280 may be made of an opaque material and be configured to prevent visibility to the LEDs 441 and 447. In some instances, the housing 1280 may have various shapes which may be different than shown in FIG. 12.

The lighting assembly 423 of FIG. 12 also has a cover 1284 extending around the lens portions 425 and 427. This cover 1284 may be made of a transparent or semi-transparent material configured to allow light emitted from the lens portion 425 and second lens portion 427 to travel through the cover 1284.

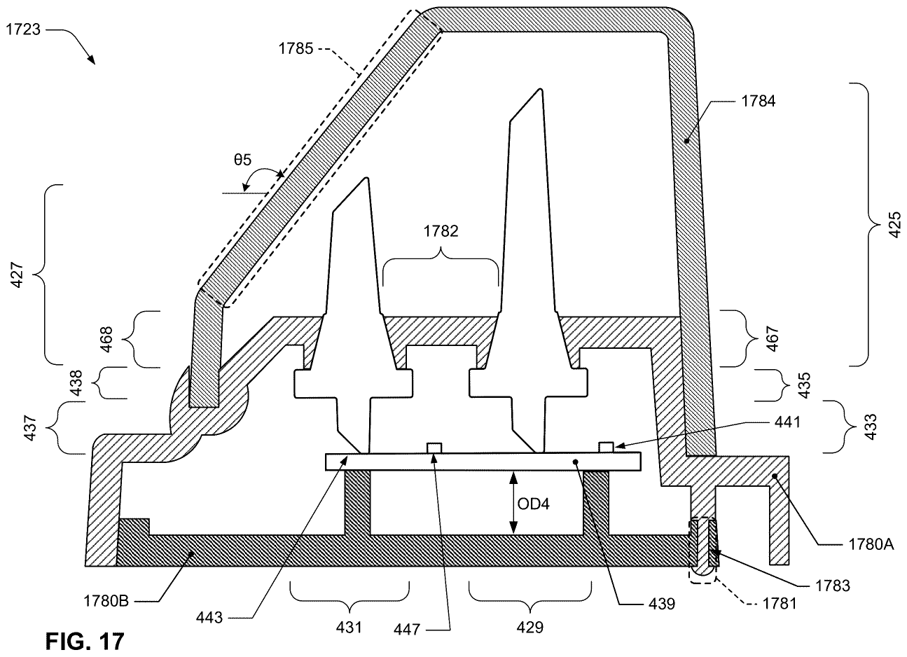

In some implementations, the housing and cover may have different shapes and configurations than in FIG. 12. For example, the housing may have multiple components that are connected together to form the lighting assembly, and the cover may have a different shape. FIG. 17 depicts the lighting assembly of FIG. 8 with another housing and cover. Here like in FIG. 12, the lighting assembly 1723 has the first and second light blades 429 and 431 described above and shown in FIGS. 7 to 11, although the second light blade 431 has a shorter second lens portion 427 than illustrated in some of the Figures, such as FIG. 8. For brevity, the features of first and second light blades 429 and 431 are not repeated here.

In FIG. 17, the lighting assembly 1723 is similar to that of FIG. 12, but with noted differences. This lighting assembly 1723 has a housing with multiple components including a first housing portion 1780A and a second housing portion 1780B. The second housing portion 1780B is coupled to the PCB 439 having the first plurality of LEDs 439 and the second plurality of LEDs 447. The PCB 439 is also offset from aspects of the second housing portion 1780B by an offset distance OD4 which may provide various advantages, such as providing room for components on the backside of the PCB 439 and also providing an air gap for cooling the PCB 439. The second housing portion 1780B is coupled with the first housing portion 1780A in order to encase, or surround, the PCB 439, the LEDs 443 and 447, and elements of the first and second light blades 429 and 431, such as the first and second light pipe portions 433 and 437, the first and second intermediate portions 435 and 438, and the first and second proximal portions 467 and 468, respectively. For instance, the first housing portion 1780A extends around some or all of the proximal portion 467 of the first lens portion 425 and the second proximal portion 468 of the second lens portion 427. This may include the housing 1280 extending in a region 1782 between the first light blade 429 and the second light blade 429. The first and second housing portions 1780A and 1780B may be made of an opaque material and be configured to prevent visibility to the LEDs 441 and 447.

The first and second housing portions 1780A and 1780B may be coupled together in various manners, such as clips, screws, bolts, or clamps. In some implementations, the first and second housing portions 1780A and 1780B may be coupled to each other using heat stakes. For example, the first housing portion 1780A may have a plurality of plastic or polymer bosses 1781, or heat stakes, that extend away from the first housing portion 1780A. The second housing portion 1780B may have a plurality of holes 1783 that are configured to receive a respective boss such that one boss extends through a respective hole. The bosses are melted with localized heat and pressure to deform the bosses and thereby couple the first housing portion 1780A to the second housing portion 1780B. The boss 1781 in FIG. 17 is encircled with a dashed rectangle and the hole 1783 through which the boss 1781 extends is also indicated. The boss 1781 is in the deformed state.

The cover 1784 in FIG. 17 has a different shape than in FIG. 12. Here, the cover 1784 has an angled portion 1785 which may be oriented at an angle similar to that of the distal ends of the light blades. For instance, referring back to FIG. 9, the distal end 457 of the first light blade 429 is oriented at the non-parallel angle with respect to the PCB top side 443, such as the obtuse angle θ3, such as 135 degrees, from a plane parallel to the PCB top side 443, or oriented with respect to the first direction 453 (not shown in FIG. 17) at an obtuse angle θ4. Similarly, in FIG. 17 the angled portion 1785 of the cover 1784 may be offset at an obtuse angle θ5, such as 135 degrees, from the plane parallel to the PCB top side 443. This angle θ5 may be the same as the angle θ3, in some cases. In some implementations, the cover 1784 may be configured to be removably coupled to the first housing portion 1780A, such as using clip, clamps, screws, or bolts, for example.

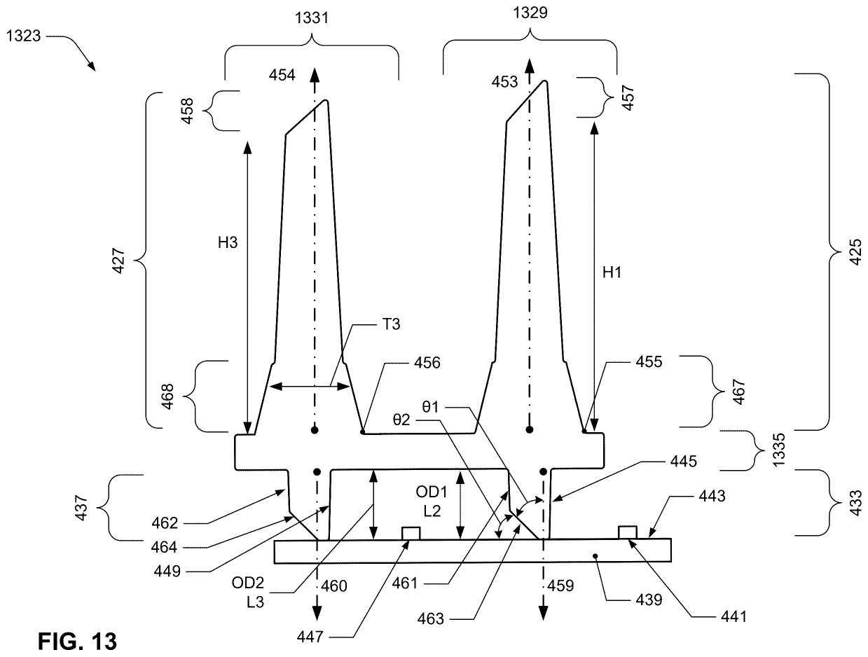

In some implementations, the first and second light blades 429 and 431 may be separate structures from each other, as illustrated in FIGS. 6 to 12. In some other implementations, the first and second light blades 429 and 431 may be the same contiguous, monolithic structure. In some such instances, each light blade may have the same intermediate portion while the lens portions and light pipe portions extend from that same intermediate portion. FIG. 13 depicts a cross-sectional view of another lighting assembly implementation; FIG. 13 is similar to FIG. 8 with noted differences. The lighting assembly 1323 here has one intermediate portion 1335 that serves as the intermediate portion 1335 for both the lens portion 425 and light pipe portion 433, as well as the second lens portion 427 and the second light pipe portion 437. In some instances, this may be considered the two light blades 431 and 429 being merged or connected at the intermediate portions. In this example, the first light blade 429 described above may be considered a first light blade portion 1329 and the second light blade 431 described above may be considered a second light blade portion 1331, with these first and second light blade portions 1329 and 1331 having the same intermediate portion 1335.

For lighting assembly 1323, the lens portion 425, light pipe portion 433, second lens portion 427, and second light pipe portion 437 may be the same as described herein. This may include the lens portion 425 having the variable height H1, tapered thickness, and proximal portion 467, and the light pipe portion 433 having the front surface 445 with the window portion (not labeled), the back surface 461 with the angled portion 463, and having the reflective coating thereon. Similarly, this may include the second lens portion 427 having the variable height H3, tapered thickness, and second proximal portion 468, and the second light pipe portion 437 having the second front surface 449 with the window portion (not labeled), the second back surface 462 with the angled portion 464, and having the reflective coating thereon. The first plurality of LEDs 441 is configured to emit light onto the front surface 445 of the first light blade portion 1329, and the second plurality of LEDs 447 is similarly configured to emit light onto the second front surface 449 of the second light blade portion 1331.

In some other implementations, the lighting assemblies may have different configurations than described above. These other implementations may have a plurality of LEDs that are vertically firing, instead of side firing, that emit light upwards from the PCB and into a horizontal light pipe portion. This horizontal light pipe portion is configured to allow the emitted light to travel in a horizontal direction with respect to the PCB through the horizontal light pipe portion to a port underneath a lens portion. In some instances, the lens portion and light pipe portion are separate structures separated on either side of the port.

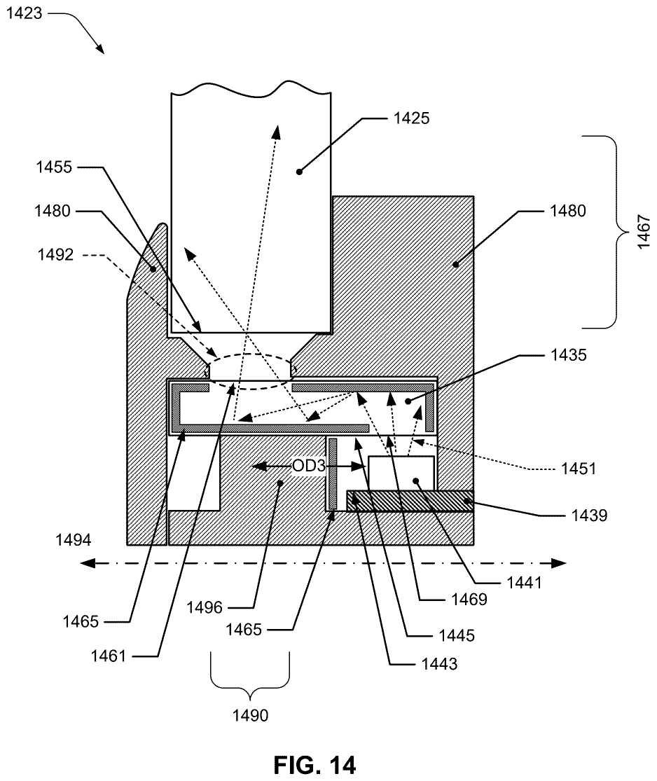

FIG. 14 depicts another implementation of a lighting assembly. Here, the lighting assembly 1423 has a PCB 1439 with an LED 1441 of a first plurality of LEDs that is vertically or top firing such that the LED 1441 emits light in a direction perpendicular to the PCB, such as upwards and away from the PCB 1439, as illustrated by light pattern 1451. The lighting assembly 1423 also has a first light pipe portion 1435 that is positioned above LED 1441 and the PCB 1439, with the LED 1441 interposed between the light pipe portion 1435 and the PCB 1439. In some instances, the light pipe portion 1453 may be positioned parallel to the PCB top side 1443. The light pipe portion 1435 has a first side 1445 that faces the PCB 1439 and LED 1441 and which may have a window portion 1469 configured to receive the emitted light 1451 from the LED 1441. The light pipe portion 1435 is configured to receive the emitted light 1451 and retain and redirect the light contained therein to a second side 1461 of the light pipe portion 1435. The second side 1461 is opposite the first side 1445 and offset farther from the PCB 1439 than the first side 1445. The light in the light pipe portion 1435 may exit the light pipe portion 1435 through an exit window portion 1490. The light may pass through the exit window portion 1490 to a port 1492 of a housing 1480 around the light pipe portion 1435 and to a lens portion 1425.

To prevent a line of sight through the port 1492 to the LED 1441, and/or to assist with diffusing the light emitted by the LED 1441, the port 1492 and exit window portion 1490 are offset from the window portion 1469 and the LED 1441 by an offset distance OD3 in a direction 1494 parallel to the PCB top side 1443. As can be seen, the window portion and LED are at one location along the direction 1494, and the exit window portion 1490 and the portion 1492 are at another location along the direction 1494. The lighting assembly 1423 is configured to direct the light contained in the light pipe portion 1435 along this direction 1494 from the window portion 1469 to the exit window portion 1490. This configuration may include the reflective coating 1465 on various surfaces, which may include on the outer surface of the light pipe portion 1435, such as the first side 1445 and second side 1461, on surfaces of the housing 1480, on the PCB 1439, on all these surfaces, or a combination thereof. In some implementations, similar to above, the reflective coating may not be positioned on the window portion 1469 and the exit window portion 1490 to allow light to enter and exit, respectively, the light pipe portion 1435. Exemplary light traveling into, within, and out of the light pipe portion is illustrated as dashed arrows.

As shown in FIG. 14, the light in the light pipe portion 1435 travels through the exit window portion 1490, through the port 1492 of the housing 1480, and into and through the lens portion 1425. In some implementations, the light pipe portion may be a separate structure from the lens portion 1425 as shown. The proximal end 1455 of the lens portion may have texturing to assist with diffusing the light received from the light pipe portion 1435, in some instances. The lens portion 1425 may also have some of the same configurations as provided above with respect to the lens portion 1425. For example, the lens portion 1425 may have the tapered thickness, a reflective coating on a portion of its proximal portion 1467, and may have a variable height following an oscillating curve. The lighting assembly 1423 may also follow a curved pathway, like described above. In some implementations, the lighting assembly 1423 may have multiple such light pipes and blades configured in the same manner, but offset from each other in the direction 1494 parallel to the PCB top side 1443. The lens portion 1425 and the light pipe portion 1435 may also be the same contiguous structure without a gap between the proximal end 1455 and the exit window portion 1461; this gap is shown in FIG. 14.

In some instances, the housing 1480 may have structures configured to block or retain light emitted by the LEDs and to support the light pipe portion. In FIG. 14, one side wall 1496 is shown and it is configured to support the light pipe portion and also to reflect the light emitted by the LED 1441 so that the light can become diffuse and travel within the light pipe portion towards the port 1492. One or more surfaces of the wall 1496 may have the reflective coating 1465, as shown.

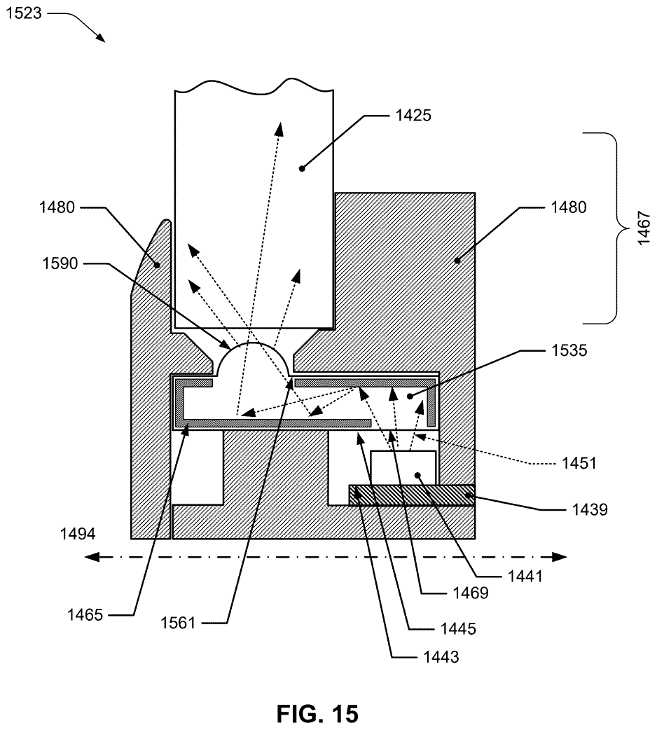

The light pipe portion 1435 of the lighting assembly 1423 may have various configurations. For example, the light pipe portion 1435 may have planar first and second surfaces 1445 and 1461 as shown in FIG. 14. In other implementations, the top surface 1461 may have one or more curved portions configured to assist with directing light towards the lens portion and/or with diffusing the emitted light. FIG. 15 depicts another implementation of the lighting assembly of FIG. 14. Here, the lighting assembly 1523 is the same as in FIG. 14 except for noted differences. In this example, the second surface 1561 has an exit window portion 1590 with a curved surface that may be considered semicircular, in some instances. This curved exit window portion 1590 may be configured to advantageously redirect the light in a more diffuse or wider emission pattern. In this implementation and the other implementations, the exit window portion may have texturing on its surface to diffuse the light traveling through the portion.

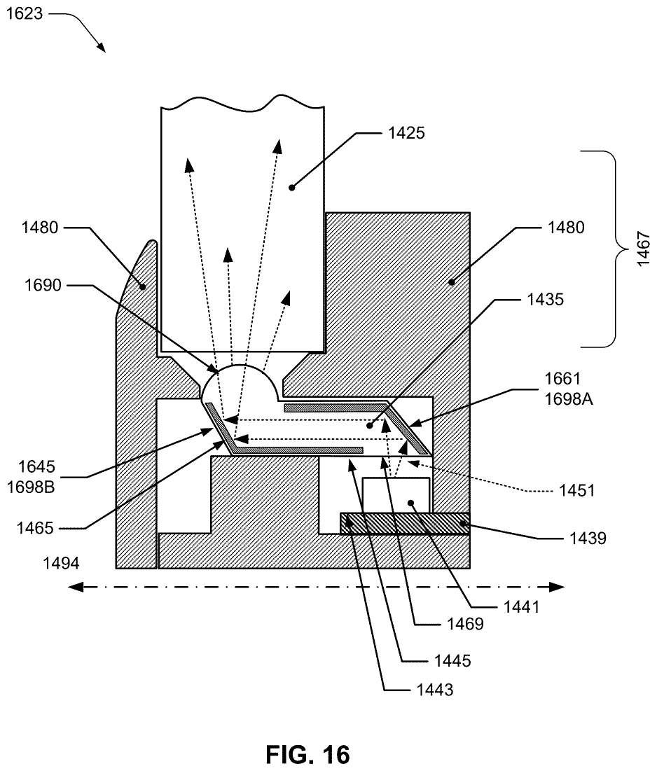

In another example, the horizontal light pipe portion may have one or more angled surfaces to redirect the light from the LEDs, similar to provided above. FIG. 16 depicts another implementation of the lighting assembly of FIG. 14. Here, the lighting assembly 1623 is the same as in FIG. 14 except for noted differences. In this example, the second surface 1661 has a first angled portion 1698A configured to receive the light emitted by the LED 1441 that passes through the window portion 1469. The first angled portion 1698A is configured to reflect and redirect the light in a different direction, such as in the direction 1494 parallel to the PCB top side 1443 and towards a second angled portion 1698B of the first surface 1645. The second angled portion 1698B is configured to reflect and redirect the light in another, different direction, such as in a direction perpendicular to the PCB top side 1443 and towards the lens portion 1425. The first angled portion 1698A, the second angled portion 1698B, or both may have the reflective coating 1465 provided thereon to assist with redirecting and reflecting the light. The configuration of the lighting assembly 1623 may advantageously prevent a line of sight between the LED and the port 1492, not labeled here, and redirect light from the LED 1441 to the lens portion 1425.

In some implementations, the first angled portion 1698A is oriented at an acute angle with respect to the PCB top side 1443, such as from about 35 degrees to about 50 degrees, including about 45 degrees, in some instances. In some implementations, the second angled portion 1698B is also oriented at an acute angle with respect to the PCB top side 1443, such as from about 35 degrees to about 50 degrees, including about 45 degrees, in some instances. In some implementations, the first angled portion 1698A and second angled portion 1698B may be parallel to each other. As can be seen, in some instances, the exit window portion 1690 may have the curved surface. In other implementations, the exit window portion may be planar like in FIG. 14.

In some implementations, multiple lighting assemblies may be positioned on an EGM and an end cap is positioned between two adjacent lighting assemblies. Referring back to FIG. 4, the EGM 404 has a second lighting assembly 487 coupled to the cabinet 416 and adjacent to the lighting assembly 423. An end cap 489 may be positioned at the junction of these two adjacent lighting assemblies to cover the end of each assembly and provide protection to these lighting assemblies and the EGM 404 by preventing tampering or damage to the lighting assemblies 423 and 487 and the EGM 404.

FIG. 18 depicts a magnified, detail view of a portion of the electronic gaming machine of FIG. 4, as identified by detail B in FIG. 4. Here, the lighting assemblies 423 and 487 are marked but for clarity, their light blades and other internal features have been removed. The lighting assembly 423 has a cover 1784, like provided above, and the other lighting assembly 487 also has a cover 1791. The end cap 489, encompassed by the dotted rectangle, is shown extending around both these covers 1784 and 1791 and covering an end 1793 of the cover 1784 and an end 1795 of the cover 1791, both of which are shown in dashed lines to indicate they are hidden underneath the end cap 489. The end cap 489 may be configured to be coupled to the cabinet 416 in an irreversible manner which allows the end cap 489 to be installed onto the cabinet 416 without the use of tools, but does not allow it to be removed or uninstalled without damaging or breaking the end cap 489. This configuration may include a plurality of snap-fit joints that have a projection and a retention portion which are configured to be inserted into the hole and the retention portion is configured to prevent its removal from the hole.

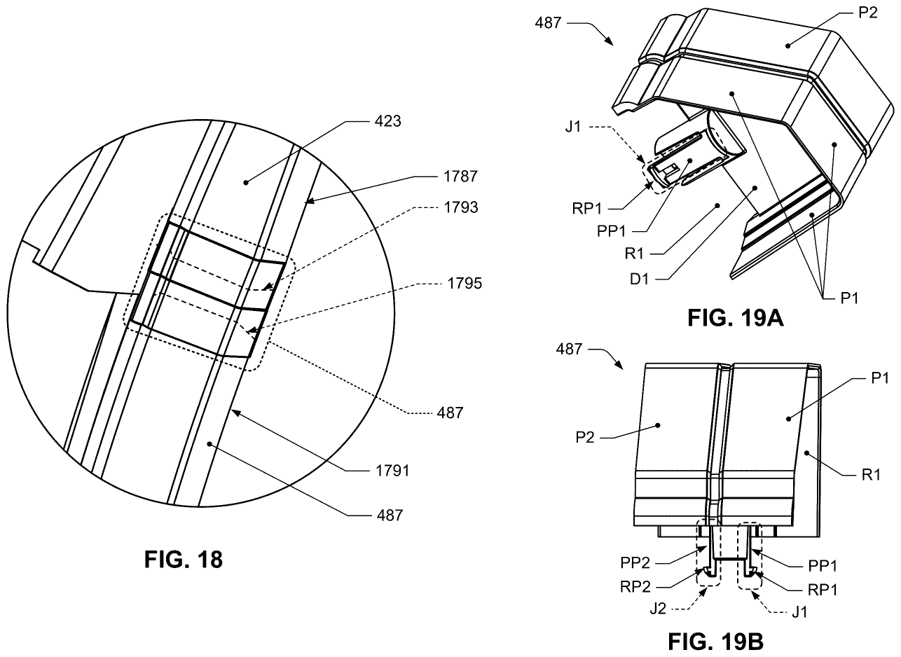

FIG. 19A depicts an off-angle view of an example end cap and FIG. 19B depicts another off-angle view of the example end cap of FIG. 19A. Here, the end cap 487 is configured to be positioned between two lighting assemblies, like those provided above. The end cap 487 has a first portion P1 that partially defines a first recess R1 and a second portion P2 that partially defines a second recess (not visible here), and a divider D1 between each portion and recess. The first portion P1 is configured to extend around an end portion of one lighting assembly, and the second portion P2 is configured to extend around an end portion of another lighting assembly. The end portions of the lighting assemblies are configured to be positioned in the first and second recesses, respectively, like illustrated in FIG. 18. The end cap 487 also has two snap-fit joints J1 and J2 that each have a projection portion PP1 and PP2, and a retention portion RP1 and RP2 that are configured to contact a feature on the EGM, such as a surface of the lighting assembly or cabinet. Once installed in the EGM, the retention portions RP1 and RP2 of the two snap-fit joints J1 and J2 are configured to maintain the coupling of the end cap 487 to the EGM and prevent the end cap 487 from being removed.

When an element is referred to as being “on,” “connected to,” or “coupled to” another element, it may be directly on, directly connected to, or directly coupled to the other element or at least one intervening element may be present. When, however, an element is referred to as being “directly on,” “directly connected to,” or “directly coupled to” another element, there are no intervening elements present. Other terms and/or phrases if used herein to describe a relationship between elements should be interpreted in a like fashion, such as “between” versus “directly between,” “adjacent” versus “directly adjacent,” “on” versus “directly on,” etc. Further, the term “connected” may refer to physical, electrical, and/or fluid connection.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A lighting assembly, comprising:
a printed circuit board (PCB) having a PCB top side and a PCB back side;
a first plurality of light emitting diodes (LEDs) positioned on the PCB top side; and
a first light blade having a monolithic body comprising a transparent material and having a light pipe portion, a lens portion, and an intermediate portion interposed between the light pipe portion and the lens portion, wherein:
the intermediate portion is offset from the PCB top side such that the light pipe portion is interposed between the PCB top side and the intermediate portion when viewed parallel to the PCB top side,
the lens portion extends away from the intermediate portion in a first direction, has a proximal end at the intermediate portion, and a distal end offset from the intermediate portion,
the light pipe portion extends away from the intermediate portion in a second direction for a second length, has a front surface, and has a back surface opposite the front surface and with an angled portion,
the angled portion is oriented at an acute angle with respect to the second direction,
the back surface has a reflective coating,
each LED:
faces the front surface of the light pipe portion,
is offset from the front surface in a direction parallel to the PCB top side by a first offset distance, and
is configured to emit light onto the front surface, and
light emitted by each LED is configured to pass through the front surface and a region of the light pipe portion, to hit the angled portion and thereby travel through the intermediate portion and the lens portion, and out the first light blade through the distal end.

2. The lighting assembly of claim 1, wherein:
the front surface has a covered portion with the reflective coating and a window portion without the reflective coating,
the window portion and the angled portion are opposite each other, and
each LED is configured to emit light onto the window portion of the front surface.

3. The lighting assembly of claim 2, wherein the window portion is perpendicular to the PCB top side.

4. The lighting assembly of claim 2, wherein the window portion has a transparency greater than 90% transparent.

5. The lighting assembly of claim 1, wherein the light pipe portion is in contact with the PCB top side.

6. The lighting assembly of claim 1, wherein the first direction and the second direction are parallel to each other.

7. The lighting assembly of claim 1, wherein the second direction is perpendicular to the PCB top side.

8. The lighting assembly of claim 1, wherein the angle ranges from 40 degrees to 50 degrees.

9. The lighting assembly of claim 1, wherein:
the intermediate portion has a top side and bottom side,
the bottom side faces the PCB top side, and
the bottom side has the reflective coating.

10. The lighting assembly of claim 1, wherein:
the intermediate portion has a thickness, and
the thickness and the second length are configured to prevent a line of sight to the plurality of LEDs through the lens portion.

11. The lighting assembly of claim 1, wherein the lens portion has a tapered thickness along the first direction.

12. The lighting assembly of claim 11, wherein:
the lens portion has a proximal region and a distal region,
the proximal region has the reflective coating, and
the distal region is larger than the proximal region and is without the reflective coating.

13. The lighting assembly of claim 1, wherein:
the PCB and the first light blade extend along a pathway for an assembly length,
the LEDs are offset from each other by a non-zero distance along the pathway, and
the distal end of the lens portion is offset from the intermediate portion by a variable offset distance along the pathway.

14. The lighting assembly of claim 13, wherein the variable offset distance follows an oscillating curve with respect to the PCB top side.

15. The lighting assembly of claim 1, wherein:
the PCB and the first light blade extend along a pathway for an assembly length,
the LEDs are offset from each other by a non-zero distance along the pathway, and
the pathway is a curve.

16. The lighting assembly of claim 1, wherein the distal end of the lens portion is oriented at an obtuse angle with respect to the PCB top side.

17. The lighting assembly of claim 1, wherein:
each LED emits light in a cone pattern, and
the LEDs are offset from each other such that the cone pattern of each LED partially overlaps with the cone pattern of an immediately adjacent LED.

18. The lighting assembly of claim 1, further comprising:
a plurality of second LEDs positioned on the PCB top side; and
a second light blade having a second monolithic body comprising a transparent material and having a second light pipe portion, a second lens portion, and a second intermediate portion interposed between the second light pipe portion and the second lens portion, wherein:
the first light blade is offset from the second light blade in the direction parallel to the PCB top side,
the first plurality of LEDs is offset from the second plurality of LEDs in the direction parallel to the PCB top side,
the second intermediate portion is offset from the PCB top side such that the second light pipe portion is interposed between the PCB top side and the second intermediate portion when viewed parallel to the PCB top side,
the second lens portion extends away from the second intermediate portion in the first direction, has a second proximal end at the second intermediate portion, and a second distal end offset from the second intermediate portion,
the second light pipe portion extends away from the second intermediate portion in the second direction for the second length, has a second front surface, and has a second back surface opposite the second front surface and with a second angled portion,
the second angled portion is oriented at a second acute angle with respect to the second direction,
the second back surface has the reflective coating,
each second LED:
faces the second front surface of the second light pipe portion,
is offset from the second front surface in the direction parallel to the PCB top side by the first offset distance, and
is configured to emit light onto the second front surface, and
light emitted by each second LED is configured to pass through the second front surface and a region of the second light pipe portion, to hit the second angled portion and thereby travel through the second intermediate portion and the second lens portion, and out the second light blade through the second distal end.

19. The lighting assembly of claim 18, wherein:
the PCB and the first light blade extend along a pathway for an assembly length,
the LEDs are offset from each other by a non-zero distance along the pathway,
the distal end of the lens portion is offset from the intermediate portion by a variable offset distance along the pathway,
the variable offset distance follows an oscillating curve with respect to the PCB top surface,
the second light blade extends along the pathway for the assembly length,
the second LEDs are offset from each other by the non-zero distance along the pathway,
the second distal end of the second lens portion is offset from the intermediate portion by a second variable offset distance along the pathway,
the second variable offset distance follows a second oscillating curve with respect to the PCB top surface, and
the oscillating curve is out of phase with the second oscillating curve.

20. An electronic gaming machine, comprising:
a cabinet defining an internal compartment;
one or more display devices connected to the cabinet; and
a lighting assembly positioned adjacent to an edge of the cabinet and having:
a printed circuit board (PCB) having a PCB top side and a PCB back side;
a first plurality of light emitting diodes (LEDs) positioned on the PCB top side;
a first light blade having a monolithic body comprising a transparent material and having a light pipe portion, a lens portion, and an intermediate portion interposed between the light pipe portion and the lens portion, wherein:
the intermediate portion is offset from the PCB top side such that the light pipe portion is interposed between the PCB top side and the intermediate portion when viewed parallel to the PCB top side,
the lens portion extends away from the intermediate portion in a first direction, has a proximal end at the intermediate portion, and a distal end offset from the intermediate portion,
the light pipe portion extends away from the intermediate portion in a second direction for a second length, has a front surface, and has a back surface opposite the front surface and with an angled portion,
the angled portion is oriented at an acute angle with respect to the second direction,
the back surface has a reflective coating,
each LED:
faces the front surface of the light pipe portion,
is offset from the front surface in a direction parallel to the PCB top side by a first offset distance, and
is configured to emit light onto the front surface,
light emitted by each LED is configured to pass through the front surface and a region of the light pipe portion, to hit the angled portion and thereby travel through the intermediate portion and the lens portion, and
the first light blade extends away from the cabinet.
